(19) United States
(12) Patent Application Publication
(10) Pub. No.: US 2026/0186766 A1
(43) Pub. Date: Jul. 2, 2026

(54) BATTERY MANAGEMENT SYSTEM AND METHOD FOR UPDATING FIRMWARE OF SLAVE DEVICES OF BATTERY MANAGEMENT SYSTEM

(71) Applicant: Grace Connection Microelectronics Limited, Zhubei City (TW)

(72) Inventors: PEI WEI CHEN, Zhubei City (TW); CHIH-HUA HUANG, Zhubei City (TW)

(73) Assignee: Grace Connection Microelectronics Limited, Zhubei City (TW)

(21) Appl. No.: 19/425,742

(22) Filed: Dec. 18, 2025

(30) Foreign Application Priority Data
Dec. 26, 2024 (TW) 113150925

(51) Int. Cl. G06F 8/65

(52) U.S. Cl. CPC G06F 8/65

(57) ABSTRACT

A method is provided for updating firmware slave devices by a master device in a battery management system. The method includes: receiving a firmware image for updating slave devices by the master device, and transmitting the firmware image to one of the slave devices; the slave device transmitting the received firmware image to another slave device, until the last slave device in the predetermined order receives the firmware image and returns an x to the master device. Each of the slave devices with the firmware image, updates its own firmware by the firmware image.

### CROSS REFERENCE

The present invention claims priority to TW113150925 filed on Dec. 26, 2024.

### BACKGROUND OF THE INVENTION

### Field of Invention

The present invention relates to a battery management system (BMS) with a wireless daisy chain network topology, and more particularly, to a method for updating the firmware of slave devices for monitoring batteries in the battery management system with the wireless daisy chain network topology.

### Description of Related Art

To improve the capability of battery energy storage, modern industrial and automotive battery energy storage systems typically adopt a series-connected battery pack configuration. As the number of batteries connected in series increases, the total DC voltage across the battery packs also accordingly increases. However, the operation and safety of a battery energy storage system must be maintained by monitoring and collecting information such as the voltage and temperature of each battery cell, by the configuration of the battery management system. Current battery energy storage system architectures often include multiple monitoring devices, each of which may be assigned to monitor a respective battery cell. In one implementation, these monitoring devices are organized in a wireless daisy chain network topology, in which dozens of such monitoring devices may be connected and operate simultaneously. Due to the bandwidth limitations of the wireless daisy chain network topology, such as a maximum transmission unit (MTU) of 128 bytes per device, it is not feasible to transmit a complete firmware image in just one time, which typically exceeds the maximum allowable transmission size for over-the-air updates. Performing firmware updates manually, such as by using update fixtures through I/O interfaces for one-by-one updating each monitoring device via engineering personnel, would result in significant time consumption and labor costs. Additionally, the battery energy storage systems typically operate in high-voltage environments, and such manual operations may bring serious safety risks to personnel. Therefore, there exists a need for a technology that enables automatic firmware updating of the battery monitoring slave devices within the wireless daisy chain network topology of the battery management system.

### SUMMARY OF THE INVENTION

In view of the aforementioned requirement, the present invention provides a battery management system (BMS) technology that utilizes radio frequency (RF) couplers or optical transceivers to enable communication among slave devices for monitoring batteries arranged in a series configuration. Through such communication, the firmware update of each slave device can be performed, to avoid manual operation in high-voltage environments.

According to one perspective of the present invention, a

method is provided for updating the firmware of each of N serially-connected slave devices by a master device in a battery management system. The master device and the N slave devices are wirelessly connected in series to form a wireless daisy chain network topology. The method includes the following steps: (1) the master device receives a firmware image for update, and transmits the firmware image to the n-th slave device among the N slave devices, where N is a positive integer and n is an integer between 1 and N; (2) the n-th slave device storing and transmitting the received firmware image according to a predetermined operation sequence, to the (n+k)-th slave device among the N slave devices, where k is a positive integer between 1 and N−1; and, (3) continuing the storing and transmitting of the firmware image sequentially according to the predetermined operation sequence, until the last slave device in the predetermined operation sequence receives the firmware image, returns an acknowledgment message to the master device, and uses the firmware image to perform firmware updates on one or more of the N slave devices that have received the firmware image.

According to another perspective of the present invention, a battery management system is provided, which includes a master device and N slave devices wirelessly connected in series. The communication of the master device and the N slave devices form a wireless daisy chain network topology. Firmware update of the N slave devices can be performed by: (1) the master device receiving a firmware image for update, and transmitting the firmware image to the n-th slave device among the N slave devices, where N is a positive integer and n is an integer between 1 and N; (2) the n-th slave device storing and transmitting the received firmware image, according to a predetermined operation sequence, to the (n+k)-th slave device among the N slave devices, where k is a positive integer between 1 and N−1; (3) sequentially storing and transmitting the firmware image according to the predetermined operation sequence, until the last slave device in the predetermined operation sequence receives the firmware image, returns an acknowledgment message to the master device, and uses the firmware image to perform firmware updates on one or more of the N slave devices that have received the firmware image (or, one or more of the slave devices received the firmware images, perform firmware updates on themselves).

The objectives, technical details, features, and benefits of the present invention can be better understood with regard to the detailed description of the embodiments below, with reference to the associated drawings.

### BRIEF DESCRIPTION OF THE DRAWINGS

FIG. 1 shows a schematic diagram of a battery system 1000 including a battery management system 200 according to multiple embodiments of the present invention.

FIG. 2 shows a schematic diagram illustrating firmware update of battery monitoring devices through a downlink data chain according to multiple embodiments of the present invention.

FIG. 3 shows a flowchart illustrating an exemplary process for performing firmware updates on the slave devices in the battery management system according to multiple embodiments of the present invention.

### DESCRIPTION OF THE PREFERRED EMBODIMENTS

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

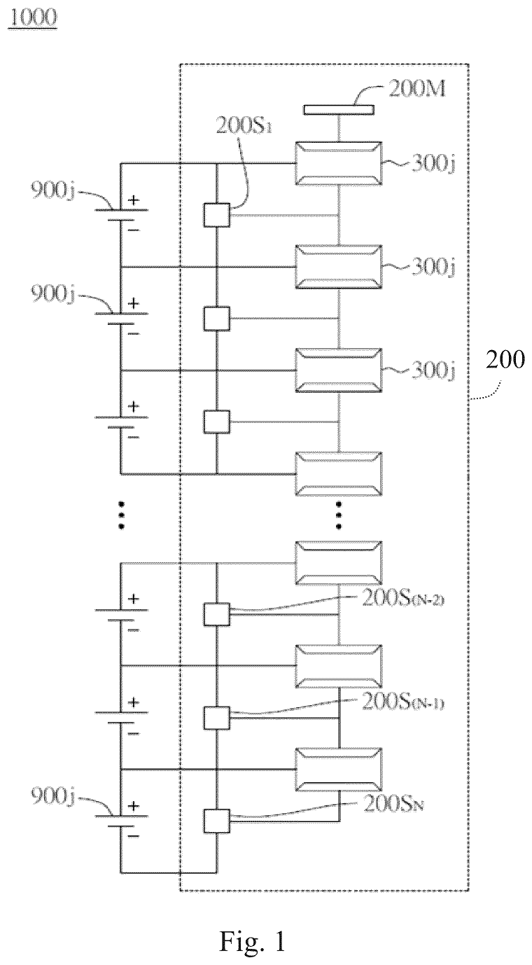

Please refer to FIG. 1, which shows a schematic diagram

of a battery system 1000 and a battery management system (BMS) 200 thereof, according to one perspective of the present invention. The battery system 1000 includes a plurality of battery cells 900j and the battery management system 200. The battery cells 900j are connected in series. During operation of the battery system 1000, these battery cells 900j need to be monitored to ensure that battery parameters such as temperature and voltage are within normal operating ranges. Therefore, each of the battery cell 900j may be provided with a corresponding battery monitoring device (e.g., the battery monitoring device 200S₁ served as the first stage, and the battery monitoring device 200S_{N} served as the last stage) to perform such monitoring.

As shown in FIG. 1, the battery management system 200 includes a master control device 200M (also referred to as the master device), battery monitoring devices 200S₁ to 200S_{N}, and a plurality of communication couplers 300j. The battery monitoring devices 200S₁ to 200S_{N} may be referred to as slave devices with respect to the master control device 200M. The communication couplers 300j may be optical couplers or radio-frequency couplers which are disposed between the master control device 200M and the first-stage battery monitoring device 200S₁, and between adjacent pairs among the battery monitoring devices 200S₁ to 200S_{N}. The master control device 200M and the battery monitoring devices 200S₁ to 200S_{N} communicate in a whispering wireless manner through the communication couplers 300j. This allows data, messages, or OTA (Over-the-Air) update content to be transmitted sequentially downstream (downlink data chain) toward the last battery monitoring device 200S_{N}, and an acknowledgment message to be returned upstream (uplink data chain) back to the master control device 200M. Thus, the master control device 200M and battery monitoring devices 200S₁ to 200S_{N} (i.e., the slave devices) form a wireless daisy chain network topology, where N is a positive integer.

Since each of the battery monitoring devices (from 200S₁ to 200S_{N}) includes its own required firmware, in order to update the firmware of each level of battery monitoring devices in the battery management system 200 and to ensure the system remains in optimal operating condition, the present invention provides a technique for firmware updating. The firmware update is achieved by sequential transmission through the downlink data chain through the battery monitoring devices, wherein a plurality of firmware segments obtained by dividing a firmware image by the master control device 200M. These firmware segments are first sent to the first-stage battery monitoring device (i.e., the first slave device 200S₁), which stores and transmits the received firmware segments, until receiving all the firmware segments. When any battery monitoring device (i.e., the first slave device 200S₁) receives all the firmware segments, the battery monitoring device can reconstruct the original firmware image to perform the firmware update.

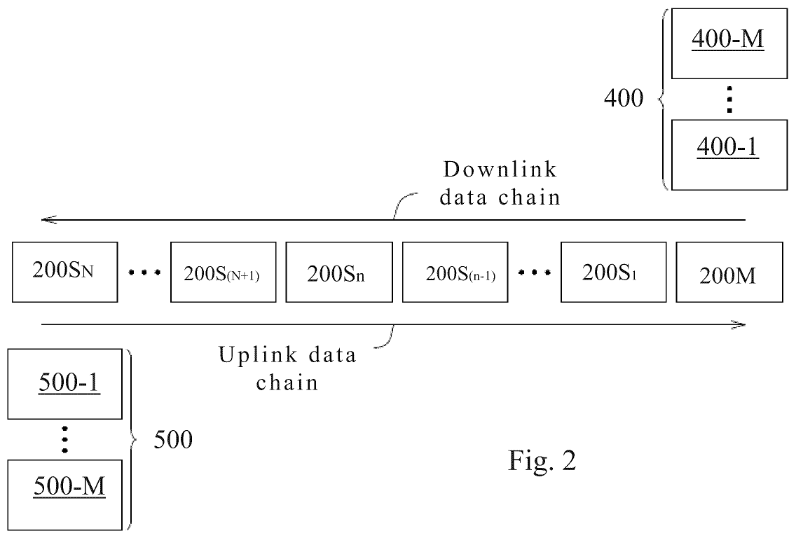

FIG. 2 shows a schematic diagram for performing firmware updates on the battery monitoring devices (battery monitoring devices 200S₁ to 200S_{N}) via a downlink data chain according to multiple embodiments of the present invention. In an established wireless daisy chain network topology, the master control device 200M may, after preparing/receiving the firmware image 400, divide the firmware image 400 into M firmware segments (e.g., firmware segments 400-1 to 400-M) by a segmentation unit of the master control device 200M. The segmentation may be performed appropriately based on the maximum transmission unit of each battery monitoring device. The master control device 200M then transmits one of the M firmware segments, for example, the firmware segment 400-1, to the first-stage battery monitoring device 200S₁. In some embodiments, the firmware image 400 may be directly transmitted without segmentation. Upon receiving firmware segment 400-1, the first-stage battery monitoring device 200S₁ stores the firmware segment 400-1 and transmits it to the second-stage battery monitoring device 200S₂. This process continues sequentially until the last-stage (or tail slave stage) battery monitoring device 200S_{N} receives firmware segment 400-1. The predetermined operation sequence for segment transmission is, for example, from battery monitoring device 200S₁ to 200S_{N}. After receiving the firmware segment 400-1, the last-stage battery monitoring device 200S_{N} returns an acknowledgment message 500 (e.g., acknowledgment message 500-1) upstream (via the uplink data chain), back to the preceding slave device 200S_{(N-1)}, and so on, until the acknowledgment message reaches the master control device 200M. Upon receiving the acknowledgment message 500-1, the master control device 200M determines that all battery monitoring devices have successfully received the firmware segment 400-1 and proceeds to transmit another firmware segment among the M firmware segments, for example, firmware segment 400-2, to the first-stage battery monitoring device 200S₁. This process is repeated until the master control device 200M transmits the final firmware segment (e.g., firmware segment 400-M) and receives the corresponding acknowledgment message 500-M from the last-stage battery monitoring device 200S_{N}, thereby confirming that all firmware segments (400-1 to 400-M) have been received by all devices.

In some embodiments, when not all battery monitoring devices in the wireless daisy chain network topology require updating, specific one or more battery monitoring devices within the topology may need firmware updates. For example, when only battery monitoring devices 200S₁, 200S₃, and 200S₇ need firmware updates, the firmware image 400 or its firmware segments may be transmitted and stored according to another example of the predetermined operation sequences (e.g., 200S₁→200S₃→200S₇), until the last device in the predetermined operation sequence (e.g., 200S₇) receives the firmware image.

For each battery monitoring device (through 200S₁ to 200S_{N}), after receiving all firmware segments (firmware segments 400-1 to 400-M), the device may reconstruct the firmware image 400 by combining the received firmware segments, and then use the reconstructed firmware image to perform its own firmware update of the battery monitoring devices.

In some embodiments, since each battery monitoring device is capable of reconstructing the firmware image 400, the firmware segments (400-1 to 400-M) may be transmitted in any order. For example, the firmware segments may be transmitted in a non-sequential manner, such as firmware segments 400-2, 400-5, 400-3, and so on, until all the M firmware segments are transmitted.

During transmitting each of the firmware segments, when the master control device 200M does not receive the acknowledgment message from the last-stage battery monitoring device 200S_{N} within a specified time period, the master control device 200M retransmits the firmware segment. For example, when transmitting firmware segment 400-3, the master control device 200M starts a time counting function. When the acknowledgment message 500-3 is not received before the time counting function expires, the master control device 200M retransmits firmware segment 400-3. This process is repeated until the acknowledgment message 500-3 is received, before which the next firmware segment is transmitted. This transmission and time counting mechanism ensures that all battery monitoring devices receive every firmware segment transmitted by the master control device 200M.

The reception and transmitting of each of the firmware segments and the acknowledgment messages by the battery monitoring devices (through 200S₁ to 200S_{N}) may be performed by controllers within each device, in cooperation with the communication couplers 300j shown in FIG. 1. For example, the controller may include a transmitting unit to manage the transmission. Similarly, the reconstruction of the firmware image 400 from the received firmware segments and the firmware update may also be performed by the controller within each battery monitoring device, such as by using a combination unit and an update unit. In some embodiments, the combination unit of the controller may verify whether the received firmware segments are sufficient for reconstructing the complete firmware image 400. For example, when the combination unit of the controller determines that the received and stored firmware segments are sufficient, it initiates the combination process to reconstruct the firmware image 400.

In some embodiments, each firmware segment may be embedded into a general message generated by the master control device 200M. In such cases, the master control device 200M may transmit an OTA (Over-the-Air) activation message via the downlink data chain to the battery monitoring devices. After receiving the OTA activation message, each of the battery monitoring devices enters an OTA mode. As described above, each of the battery monitoring devices transmits the received OTA activation message to the next stage device in the predetermined operation sequence, until the master control device 200M receives an acknowledgment message sent by the last-stage battery monitoring device 200S_{N} in the predetermined operation sequence. This indicates that all battery monitoring devices have received the OTA activation message and have entered the OTA mode. The master control device 200M may then begin transmitting the firmware segments. When no acknowledgment message from the last-stage battery monitoring device 200S_{N} is received, the master control device 200M retransmits the OTA activation message until the corresponding acknowledgment message is received. This ensures that all devices receive the OTA activation message and enter the OTA modes.

When the battery monitoring devices enter the OTA mode and receive firmware segments encapsulated in general messages, a filtering function (e.g., a filtering unit) implemented in the controller of each battery monitoring device may be used to filter out any data other than the firmware segment within the message, so that only the firmware segment is stored. The general message including the firmware segment may then be copied and transmitted to the next-stage battery monitoring device. As previously described, the master control device 200M may retransmit the same firmware segment when it does not receive the corresponding acknowledgment message. In such cases, the battery monitoring devices that have received the same firmware segments, may use the filtering function (e.g., filtering unit) of their controller to filter out the duplicate firmware segments, thereby ensuring that redundant data is not stored. After completing the firmware update, each of the battery monitoring devices may reset and exit the OTA mode. Alternatively, when the firmware update is not completed or fails within a specified time period, the device may also reset and exit the OTA mode.

In some embodiments, when not all battery monitoring devices in the wireless daisy chain network topology, require updating, one or more battery monitoring devices can be designated to enter the OTA mode. For example, when only the battery monitoring devices 200S₁ and 200S₃ require firmware updating, the OTA activation message may be transmitted in accordance with one example of the predetermined operation sequence (e.g., 200S₁→200S₃) so that only the designated devices enter the OTA mode; the process continues until the last device in the predetermined operation sequence receives the OTA activation message.

In some embodiments, the master control device 200M may also optionally include related functions to firmware updating, such as receiving firmware segments, transmitting firmware segments, filtering messages, reconstructing firmware images, and performing firmware updates. These allow the master control device 200M to serve as a slave device to another master device in different configurations.

Accordingly, through the above-described embodiments, after each of the battery monitoring devices receives the firmware segments of the firmware image, the firmware image may be reconstructed from the firmware segments, to perform a firmware update on the corresponding battery monitoring device itself.

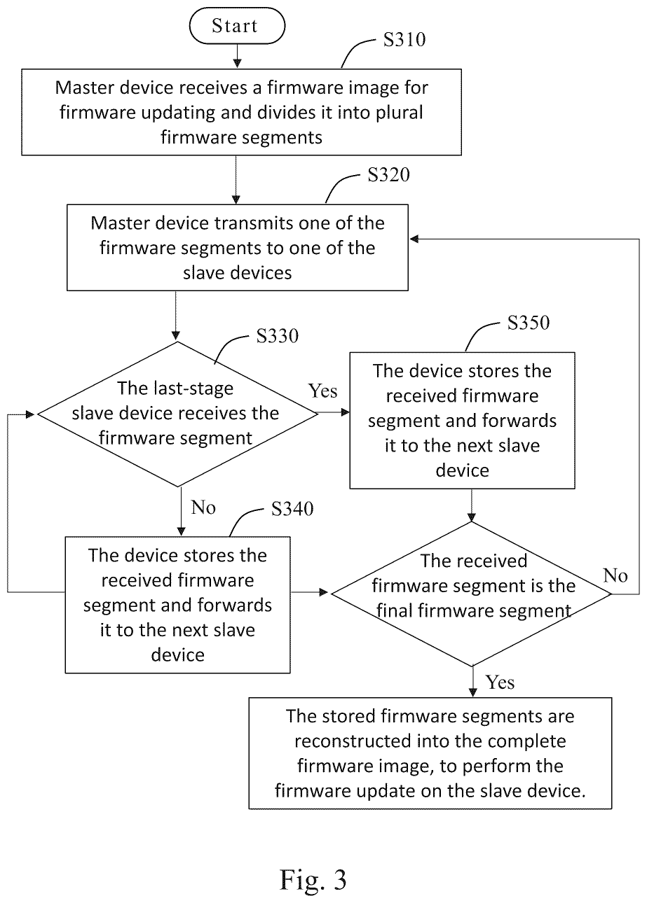

FIG. 3 is a flowchart illustrating an exemplary process for performing firmware updates on the slave devices in the battery management system (e.g., battery management system 200 in FIG. 1). For example, the battery monitoring devices 200S₁ to 200S_{N} serve as the slave devices shown in FIGS. 1 and 2. In step S310, the master device (e.g., the master control device 200M shown in FIGS. 1 and 2) receives a firmware image (e.g., firmware image 400 in FIG. 2) for firmware updating and divides it into a plurality of firmware segments (e.g., firmware segments 400-1 to 400-M in FIG. 2). In step S320, the master device transmits one of the firmware segments to one of the slave devices (e.g., 200Sn in FIG. 2), for example, via the downlink data chain. In step S330, the slave device receiving the firmware segment determines whether it is the last-stage slave device (e.g., whether it is the battery monitoring device 200S_{N} in FIG. 2, or whether it is the last device in the predetermined operation sequence). When it is not, the process proceeds to step S340, wherein the device stores the received firmware segment and transmits it to the next slave device (e.g., the battery monitoring device 200S(n+1) or another battery monitoring device). When it is, the last-stage device, the process proceeds to step S350, wherein the battery monitoring device stores the firmware segment and sends an acknowledgment message (e.g., acknowledgment message 500 in FIG. 2) to the master device, for example, via the uplink data chain. Regardless of whether the battery monitoring device is the last-stage device, the process continues to step S360, in which the device determines whether the received firmware segment is the final firmware segment (e.g., firmware segment 400-M in FIG. 2 or the sent last firmware segment). That is, it checks whether all firmware segments (the firmware segments 400-1 to 400-M) have been received. When it is not, the process returns to step S320, where the master device continues transmitting the remaining firmware segments via the downlink data chain. When all firmware segments have been received, the process proceeds to step S370, wherein the stored firmware segments are reconstructed into the complete firmware image, and the firmware update is performed on the slave device using the reconstructed firmware image.

According to some embodiments, when the master device transmits a firmware segment but does not receive an acknowledgment message from the last-stage slave device within a specified time period, the master device retransmits the firmware segment.

According to some embodiments, the slave device filters out duplicate firmware segments by a filtering unit included in its controller, such that only one copy of the same firmware segment is stored.

In some embodiments, before transmitting the firmware segments to the slave devices, the master device transmits an OTA activation message to the slave devices. The slave devices enter the OTA mode based on the received OTA activation message and sequentially transmit the OTA activation message to other slave devices according to the predetermined operation sequence, until the last-stage slave device in the predetermined operation sequence receives the OTA activation message, enters the OTA mode, and returns an acknowledgment message to the master device.

In some embodiments, after receiving the OTA acknowledgment message, the master device transmits the firmware segment by embedding it into a general message.

In some embodiments, in the OTA mode, the slave device filters out data other than the firmware segment from the message by a filtering unit included in the controller (in the slave device) to store the firmware segment. The slave device also copies and transmits the general message including the firmware segment by a transmitting unit included in the controller.

As described above, the technology provided by the present invention enables, in the battery management system with the wireless daisy chain network topology, the master device to receive the firmware image for updating the firmware of the slave devices. The firmware image is divided into a plurality of firmware segments which are sequentially transmitted and transmitted through the data chain to each slave device until the last-stage slave device returns the acknowledgment message. This ensures that all slave devices have received all firmware segments, to reconstruct the firmware image and to perform firmware updates on themselves. In the OTA transmission, the segmented firmware image can be delivered in accordance with the maximum transmission unit of each slave device in the battery management system. This approach allows firmware updates to be completed across the all slave devices without manual intervention, thereby maintaining the battery management system in its most up-to-date/optimal state.

The above description discloses distinctive features through several embodiments and/or examples for implementing the present invention. The components and configurations described above are substantially for illustrating the implementations of the present invention. These descriptions are not intended to limit the scope of the present invention. Further, repeated reference symbols or markings may appear in some embodiments for illustrative clarification purposes. Such repetition does not necessarily imply any necessary connection between the described embodiments or configurations.

The present invention has been disclosed with reference to the above the embodiments, which are not intended to limit the spirit and scope of the present invention. A person skilled in the art to which the present disclosure pertains may make various modifications and adjustments without departing from the spirit and scope of the present disclosure. Accordingly, the scope of protection of the present invention can be defined by the claims appended below.

The technical wordings/terms in this specification are based on customary understanding of the art. Regarding the wording/term described or defined in this specification, the interpretation of that wording is preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

What is claimed is:

1. A method for updating firmware of N slave devices in serial connection in battery management system by a master device, wherein the master device and the N slave devices are wirelessly connected in a wireless daisy chain network topology, the method including:

(1) receiving a firmware image for updating the N slave devices by the master device, and transmitting the firmware image to an n-th slave device among the N slave devices, wherein N is a positive integer and n is another positive integer between 1 and N;

(2) the n-th slave device storing the received firmware image and transmitting the firmware image to an (n+k)-th slave device among the N slave devices, according to a predetermined operation sequence, wherein k is a positive integer between 1 and (N−1); and

(3) sequentially storing and transmitting the firmware image from one slave device to the next slave device in the predetermined operation sequence, until the last slave device receives the firmware image, and returns an acknowledgment message to the master device, and one or more of the slave devices received the firmware images perform firmware updates on themselves.

2. The method according to claim 1, wherein the step (1) further includes: the master device dividing the firmware image into M firmware segments and transmitting an m-th firmware segment among the M firmware segments, to an n-th slave device among the N slave devices, wherein M is a positive integer and m is a positive integer between 1 and M;
wherein the step (2) further includes: the n-th slave device further storing and transmitting the m-th firmware segment to an (n+k)-th slave device according to the predetermined operation sequence;
and wherein the step (3) further includes: sequentially storing and transmitting the m-th firmware segment according to the predetermined operation sequence, until the last slave device in the predetermined operation sequence receives the m-th firmware segment and returns an acknowledgment message to the master device.

3. The method according to claim 2, further including:

(4) after receiving the acknowledgment message, the master device transmitting an (m+i)-th firmware segment among the M firmware segments, to the n-th slave device among the N slave devices, wherein i is a positive integer between 1 and (M−1); and
repeating the steps (2) to (4), to sequentially transmit each of the M firmware segments, until the N-th slave device receives all the M firmware segments and returns the acknowledgment message to the master device;
wherein, after receiving all the M firmware segments, each of the N slave devices combines the stored M firmware segments to reconstruct the firmware image.

4. The method according to claim 3, wherein when the acknowledgment message from the N-th slave device served as the last device in the predetermined operation sequence, is not received within a specified period of time by the master device after the master device transmits the m-th firmware segment among the M firmware segments, the master device retransmits the m-th firmware segment.

5. The method according to claim 4, wherein, a filtering unit of a controller in each of the N slave devices, filters out duplicate receptions of the m-th firmware segment, to store only one of the received m-th firmware segments.

6. The method according to claim 3, wherein, before the master device transmitting the m-th firmware segment among the M firmware segments, to the n-th slave device among the N slave devices, the method includes:
the master device transmitting an OTA activation message (over-the-air activation message) to the n-th slave device among the N slave devices;
the n-th slave device entering an OTA mode in response to the OTA activation message, and transmitting the OTA activation message to the (n+k)-th slave device among the N slave devices according to the predetermined operation sequence; and
the slave devices sequentially transmitting the OTA activation message until the last slave device in the predetermined operation sequence receives the OTA activation message, enters the OTA mode, and returns an OTA acknowledgment message to the master device.

7. The method according to claim 6, wherein, after receiving the OTA acknowledgment message, the master device embeds the m-th firmware segment into a message and transmits the message.

8. The method according to claim 7, wherein, when each of the N slave devices is in the OTA mode, the slave device filters the message other than the m-th firmware segment from the message, stores the m-th firmware segment by a filtering unit of a controller in the slave device, copies and transmits the message including the m-th firmware segment by a transmitting unit of the controller.

9. A battery management system, including:
a master device; and
N slave devices wirelessly connected in series, wherein the master device and the N slave devices form a wireless daisy chain network topology;
wherein firmware of the N slave devices is updated by:
(1) the master device receiving a firmware image for update, and transmitting the firmware image to a n-th slave device among the N slave devices, where N is a positive integer and n is a positive integer between 1 and N;
(2) the n-th slave device storing and transmitting the received firmware image to the (n+k)-th slave device among the N slave devices according to the predetermined operation sequence, where k is a positive integer between 1 and N−1;
(3) sequentially storing and transmitting the firmware image according to the predetermined operation sequence, until the last slave device in the predetermined operation sequence receives the firmware image, returns an acknowledgment message to the master device, and performs firmware updates on one or more of the N slave devices receiving the firmware images.

10. The battery management system according to claim 9, wherein the master device further includes a segmentation unit to divide the firmware image into M firmware segments, and the master device transmits the m-th firmware segment among the M firmware segments to the n-th slave device, where M is a positive integer and m is a positive integer between 1 and M;
wherein the n-th slave device storing and transmitting of the received firmware image which includes the m-th firmware segment stored and transmitted according to the predetermined operation sequence; and
wherein the step of sequential storing and transmitting of the firmware image includes: sequentially storing and transmitting of the m-th firmware segment until the last slave device in the predetermined operation sequence receives the m-th firmware segment, and returns the acknowledgment message to the master device.

11. The battery management system according to claim 10, wherein the firmware update of the N slave devices further includes:

(4) after receiving the acknowledgment message, the master device transmitting the (m+i)-th firmware segment among the M firmware segments, to the n-th slave device among the N slave devices, where i is a positive integer between 1 and M−1; and

(5) repeating the step (2) through the step (4) to sequentially transmit each of the M firmware segments until the N-th slave device receives all M firmware segments and returns the acknowledgment message to the master device;
wherein after receiving all the M firmware segments, each of the N slave devices combines the stored M firmware segments to reconstruct the firmware image.

12. The battery management system according to claim 11, wherein after the master device transmits the m-th firmware segment among the M firmware segments, the master device further start a time counting function for checking whether the master device does not receive an acknowledgment message within a specified time period from the N-th slave device served as the last device among the N slave devices in a predetermined operation sequence; and wherein when no acknowledgment message is received within the specified time period, the master device retransmits the m-th firmware segment.

13. The battery management system according to claim 12, wherein each of the N slave devices includes a controller with a filtering unit that filters out duplicate receptions of the m-th firmware segments, and stores only one of the m-th firmware segments.

14. The battery management system according to claim 11, wherein, before the master device transmits the m-th firmware segment among the M firmware segments, to the n-th slave device among the N slave devices, the system performs the following steps:
the master device transmitting an over-the-air activation message (OTA activation message) to the n-th slave device among the N slave devices;
the n-th slave device entering an OTA mode in response to the OTA activation message, and transmitting the OTA activation message to the (n+k)-th slave device among the N slave devices according to the predetermined operation sequence; and
sequentially transmitting the OTA activation message until the slave device at the final stage in the predetermined operation sequence receives the OTA activation message, enters the OTA mode, and returns an OTA acknowledgment message to the master device.

15. The battery management system according to claim 14, wherein, after receiving the OTA acknowledgment message, the master device embeds the m-th firmware segment into a message and transmits the message.

16. The battery management system according to claim 15, wherein each of the N slave devices includes a controller with a filtering unit and a transmitting unit;
wherein in the OTA mode, the filtering unit filters out data other than the m-th firmware segment from the message, and store the m-th firmware segment; and
wherein the transmitting unit copies and transmits the message including the m-th firmware segment.
